(19) United States
(12) Patent Application Publication
(10) Pub. No.: US 2021/0162374 A1
(43) Pub. Date: Jun. 3, 2021

(54) STRUCTURED CATALYSTS FOR PRE-REFORMING HYDROCARBONS

(71) Applicants: SAUDI ARABIAN OIL COMPANY, Dhahran (SA); Korea Advanced Institute of Science and Technology, Daejeon (KR)

(72) Inventors: Sai P. Katikaneni, Dhahran (SA); Joongmyeon Bae, Daejeon (KR); Sangho Lee, Daejeon (KR); Minseok Bae, Daejeon (KR)

(73) Assignees: SAUDI ARABIAN OIL COMPANY, Dhahran (SA); Korea Advanced Institute of Science and Technology, Daejeon (KR)

(21) Appl. No.: 17/174,255

(22) Filed: Feb. 11, 2021

Related U.S. Application Data
(62) Division of application No. 15/408,892, filed on Jan. 18, 2017, now abandoned.

(51) Int. Cl. B01J 23/10; C01B 3/40; B01J 23/89; B01J 35/04; B01J 37/02; B01J 37/08; B01J 37/18; B01J 37/06; H01M 8/0612; B01J 37/00; B01J 23/83; B01J 23/00

(52) U.S. Cl. CPC B01J 23/10; H01M 2008/1293; B01J 23/894; B01J 35/04; B01J 37/024; B01J 37/08; B01J 37/18; B01J 37/06; B01J 37/0236; H01M 8/0618; B01J 37/0018; B01J 37/0217; B01J 23/83; B01J 23/002; B01J 37/0219; B01J 37/0036; B01J 37/0244; C01B 2203/0227; C01B 2203/066; C01B 2203/1064; C01B 3/40

(57) ABSTRACT

Provided herein are structured catalysts, methods of making structured catalysts, and methods of using structured catalysts for pre-reforming of hydrocarbons. The structured catalysts contain a structured catalyst substrate, a first coating containing cerium-gadolinium oxide; and a second coating containing nickel and cerium-gadolinium oxide.

### RELATED APPLICATIONS

This application is a divisional application of and claims priority from U.S. Nonprovisional application Ser. No. 15/408,892, titled Structured catalysts for pre-reforming hydrocarbons, which was filed on Jan. 18, 2017 and is incorporated by reference in its entirety for purposes of United States patent practice.

### TECHNICAL FIELD

The disclosure relates to structured catalysts for pre-reforming of hydrocarbons. More particularly, the disclosure relates to structured catalysts, methods of making structured catalysts, and methods of using structured catalysts for pre-reforming of hydrocarbons.

### BACKGROUND OF THE INVENTION

Catalysts for chemical reactions generally include homogeneous solution catalysts and heterogeneous solid catalyst. Heterogeneous solid catalysts may include loose particle type catalysts and structured type catalysts, where the structured catalysts are characterized by having some type of formed or rigid structure having flow channels or pathways for reactants to travel through the structure. Structured catalysts can include monolithic catalysts, membrane catalysts, and arranged catalysts. Monolithic catalysts are referred to as honeycomb catalysts and generally are in the form of a continuous unitary structure having small passages for flow of reactants through the structure while interacting with a catalytic material in the structure to catalyze selected chemical reactions. Arranged catalysts generally include particulate catalysts arranged in arrays and further include structural catalysts, where a structure may include corrugated sheets superimposed and stacked to form a catalyst bed. Structured catalysts provide certain advantages over unstructured particulate catalyst, including providing better control of pressure drop, controlling diffusion length or pathway, preventing flow bypass of reactants, and controlling hot spot formation and thermal runaway problems. Accordingly, there may be certain catalyst systems using unstructured particulate catalysts that can be improved by developing a structured catalyst system for catalyzing similar types of chemical reactions. A replacement structured catalyst can provide certain cost and performance advantages over an unstructured catalyst.

Structured catalysts generally include some type of structural support with a catalyst associated to surfaces of the support. Various methods may be used for application of a catalyst material to a support. The application process and catalyst materials may have an impact on the performance of a structured catalyst, including how long the structured catalyst performs adequately in a selected implementation. Generally, as the materials and processes for creating a structured catalyst are a significant cost, increasing lifetime of a structured catalyst can provide certain cost benefits, as well as certain performance benefits over the lifetime of the catalyst.

An implementation of structured catalysts includes use in a pre-reforming catalyst bed in a solid oxide fuel cell (SOFC). As the reactants in a SOFC include hydrogen, carbon monoxide, methane, and ethane, a pre-reforming catalyst bed allows the use of heavier hydrocarbons to be fed to a pre-reforming catalyst bed for conversion to a gas stream containing lighter hydrocarbons for powering the SOFC. The heavier hydrocarbons generally include those with more than four carbon atoms and may include gasoline, jet fuel, biofuels, and diesel. However, using heavier fuels may be problematic as coking may occur on the anode of the SOFC. Accordingly, if heavier hydrocarbons are to be used as a feed source to a SOFC, there is a need for a relatively high conversion to light hydrocarbons via pre-reforming to minimize coking on the anode of a SOFC.

### SUMMARY OF THE INVENTION

Various embodiments of structured catalysts are provided to address some of the shortcomings of the art, such as the need for increased conversion of hydrocarbons, decreased consumption of amount of catalysts for similar or higher reaction efficiency, and extended operational life. Provided here are structured catalysts that contain a structured catalyst substrate and coatings containing cerium-gadolinium oxide. In an embodiment, the structured catalyst contains a structured catalyst substrate, a first coating containing cerium-gadolinium oxide and applied to a surface of the structured catalyst substrate; and a second coating containing nickel and cerium-gadolinium oxide and applied to the first coating.

The second coating can further contain ruthenium. The second coating can further contain nickel-ruthenium based catalysts. The structured catalyst substrate can be a monolithic structured catalyst substrate. The structured catalyst can contain two or more layers of the first coating. The structured catalyst can contain at least five layers of the first coating. The structured catalyst can contain two or more layers of the second coating. The structured catalyst can contain at least five layers of the second coating.

Certain embodiments include processes for producing the structured catalysts. An exemplary process includes applying a first coating to a surface of the structured catalyst substrate using a first coating solution containing a cerium-gadolinium oxide powder and a first binder to form a first coated structured catalyst substrate; calcining the first coated structured catalyst substrate to form a first calcined structured catalyst substrate; applying a second coating to surfaces of the first calcined structured catalyst substrate using a second coating solution containing a second binder and nickel and cerium-gadolinium oxide to form a second coated structured catalyst substrate; calcining the second coated structured catalyst substrate to form a second calcined structured catalyst substrate; and activating the second calcined structured catalyst substrate by heating in the presence of hydrogen to form a structured catalyst. In certain embodiments, the step of activating can further include heating the second calcined structured catalyst substrate at a temperature of 500° C. for at least four hours in an atmosphere of 30% hydrogen and 70% nitrogen.

The structured catalyst substrate can be a monolithic structured catalyst substrate. The process can include applying two or more layers of the first coating. The process can include applying two or more layers of the second coating. The first binder and the second binder can contain the same polymeric materials or be made of different polymeric materials. In certain embodiments, the first binder and the second binder contain polyvinyl butyral resin.

In certain embodiments, the process can include cleaning surfaces of the structured catalyst substrate before applying the first coating. The process can further include washing the structured catalyst substrate with a 30% nitric acid solution; and drying the structured catalyst substrate at 120° C. for at least one hour. The step of applying the first coating to a surface of the structured catalyst substrate can further include contacting the structured catalyst substrate with the first coating solution; removing excess amounts of the first coating solution to provide a film of the first coating solution on the structured catalyst substrate; and drying the film on the structured catalysts substrate. The steps of contacting, removing, and drying can be sequentially repeated at least five times to form the first coating on the structured catalyst substrate. In certain embodiments, the first coating solution further contains a solvent, a dispersant, and a plasticizer.

The step of applying the second coating to a surface of the first calcined structured catalyst substrate can further include contacting the first coated structured catalyst substrate with the second coating solution; removing excess amounts of the second coating solution to provide a film of the second coating solution on the first coated structured catalyst substrate; and drying the film on the first coated structured catalysts substrate. The steps of contacting, removing, and drying can be sequentially repeated at least five times to form the second coating on the first coated structured catalyst substrate. The second coating solution can further contain a solvent, a dispersant, and a plasticizer.

Certain embodiments include processes for pre-reforming a hydrocarbon fuel using the structured catalysts. An exemplary process for pre-reforming a hydrocarbon fuel includes the steps of: feeding to a catalytic pre-reformer air, steam, and a hydrocarbon fuel including C2 and greater hydrocarbons; and pre-reforming, in the catalytic pre-reformer, the hydrocarbon fuel to produce a reformate exit stream including hydrogen and methane. The catalytic pre-reformer used here includes a structured catalyst having a structured catalyst substrate, a first coating containing cerium-gadolinium oxide; and a second coating containing nickel and cerium-gadolinium oxide. The hydrocarbon fuel is selected from the group consisting of natural gas, propane, gasoline, jet fuel, biofuel, diesel, and kerosene.

Certain embodiments include solid oxide fuel cell devices in flow communication with pre-reformers. Exemplary pre-reformers used here include pre-reformers containing a structured catalyst to pre-reform a hydrocarbon fuel source into a gas stream containing hydrogen and methane. The structured catalyst containing a structured catalyst substrate, a first coating containing cerium-gadolinium oxide; and a second coating containing nickel and cerium-gadolinium oxide. The solid oxide fuel cell in flow communication with the structured catalyst pre-reformer to receive the gas stream containing hydrogen and methane.

### BRIEF DESCRIPTION OF THE DRAWINGS

Embodiments will be readily understood by the following detailed description in conjunction with the accompanying drawings. To facilitate this description, like reference numerals designate like structural elements or procedures in a method. Embodiments are illustrated by way of example and not by way of limitation in the figures of the accompanying drawings.

FIGS. 1A and 1B are scanning electron microscope (SEM) images of a structured catalyst, in accordance with various embodiments.

FIG. 2 is a schematic illustration of a process for producing a structured catalyst, in accordance with various embodiments.

FIG. 3 is a schematic illustration of a process for pre-reforming a hydrocarbon fuel, in accordance with various embodiments.

FIG. 4 is a schematic illustration of a solid oxide fuel cell device with a pre-reformer including a structured catalyst, in accordance with various embodiments.

FIG. 5 is a schematic illustration of an experimental system for catalytic activity testing of pre-reforming catalysts, in accordance with various embodiments.

FIG. 6 is a graphical representation of a conversion of n-dodecane as a function of time for structured catalysts with and without the CGO pre-coating layer for a Ni—Ru/CGO catalyst, in accordance with various embodiments.

FIGS. 7A and 7B are scanning electron microscopy (SEM) images of spent structured catalysts without and with a CGO pre-coating, in accordance with various embodiments.

FIGS. 8A, 8B, and 8C are SEM images of three structured catalysts with five, seven, and nine layers of Ni—Ru/CGO coating respectively, in accordance with various embodiments.

FIGS. 9A, 9B, 9C, and 9D are scanning electron microscope images of structured substrates with CGO pre-coating followed by heat treatment at 800° C., 900° C., 1000° C., and 1,100° C., respectively, in accordance with various embodiments.

FIG. 10 is a graphical representation of a comparison of a granular catalyst and a structured catalyst in a pre-reforming device, in accordance with various embodiments. The fuel used for the comparison was n-dodecane.

### DETAILED DESCRIPTION

The present disclosure describes various embodiments related to processes, devices, and systems for structured catalysts for pre-reforming of heavier hydrocarbons to produce lighter hydrocarbons. In various embodiments, the structured catalysts may be implemented in fuel cell applications. Further embodiments may be described and disclosed.

In the following description, numerous details are set forth in order to provide a thorough understanding of the various embodiments. In other instances, well-known processes, devices, and systems may not been described in particular detail in order not to unnecessarily obscure the various embodiments. Additionally, illustrations of the various embodiments may omit certain features or details in order to not obscure the various embodiments.

In the following detailed description, reference is made to the accompanying drawings that form a part of this disclosure. Like numerals may designate like parts throughout the drawings. The drawings may provide an illustration of some of the various embodiments in which the subject matter of the present disclosure may be practiced. Other embodiments may be utilized, and changes may be made without departing from the scope of this disclosure.

The description may use the phrases “in some embodiments,” “in various embodiments,” “in an embodiment,” or “in embodiments,” which may each refer to one or more of the same or different embodiments. Furthermore, the terms “comprising,” “including,” “having,” and the like, as used with respect to embodiments of the present disclosure, are synonymous.

Various embodiments disclosed and described here relate to structured catalysts for pre-reforming of hydrocarbons such as diesel, including embodiments of structured catalysts, methods of making the structured catalysts, and methods of using the structured catalysts. Various embodiments may be useful for fuel cell applications such as in a solid oxide fuel cell application, where diesel fuel is subjected to pre-reforming using embodiments of the structured catalysts. Generally, diesel fuel is an attractive hydrocarbon fuel for fuel cell applications because of a relatively high energy density, well-constructed infrastructure for fueling options, and relatively high safety characteristics of diesel as a fuel. Diesel fuel is comprised of mostly C12 to C24 hydrocarbons. In a fuels cell application, generally diesel is converted into a synthetic-gas (syngas), which is fed to a fuel cell. In pre-reforming, heavy hydrocarbons, including diesel, are converted into methane containing syngas.

In comparison to various reforming methods, pre-reforming using the structured catalysts disclosed and described in various embodiments may be more effective for stack cooling in a SOFC. For example, without being bound by theory, irreversible heat is generated by electrochemical reactions in a SOFC. Unless the heat is removed, the temperature of upper cells increases. This increase in temperature may lead to failure of the SOFC cell, the sealant, and the interconnect materials. Pre-reforming to produce methane containing syngas is a way to remove the irreversible heat by feeding the syngas to the SOFC. A SOFC directly uses the syngas by internal reforming on the anode. This internal reforming absorbs the irreversible heat, because internal reforming is endothermic. Therefore, a temperature increase in a SOFC may be minimized by feeding syngas produced by pre-reforming.

In comparison to other catalysts for pre-reforming, structured catalysts disclosed and described in various embodiments for pre-reforming can be more effective for minimizing coke formation, and thus, more effective by having a higher tolerance to coke formation. Generally, high tolerance to coke formation and high activity under 500° C. are desirable for a diesel pre-reforming catalyst. Coke formation tends to deactivate a catalyst, so minimizing coke formation is desirable. Temperatures below about 500° C. tend to reduce coke formation. Additionally, having a catalyst with better tolerance to coke formation is desirable as activity is not reduced as much when coke is formed, thereby extending catalyst activity over a longer period of time. Accordingly, high activity at lower temperatures is desirable for a pre-reforming catalyst as coke formation is reduced and thus activity is impacted less, while catalytic activity is maintain at the lower temperatures by virtue of the catalyst properties and reduced coke formation.

The structured catalysts disclosed and described generally provide improved heat transfer in comparison to granulated catalysts. This improved heat transfer may be important for practical applications of hydrocarbon pre-reforming as the reaction is endothermic and thus heat is supplied from an external source to the catalyst. To effectively provide such heat, the higher heat transfer properties of the structured catalyst may be necessary for effective pre-reforming, in comparison to a granulated catalyst. An additional benefit of the structured catalysts disclosed and described here, is to accommodate an improved SOFC design via making the design simpler and compact, owing to the improved properties of structured catalysts. Moreover, as catalysts account for a large portion of a pre-reformer's cost, a cost reduction may be achieved using a structured catalyst in comparison to a granulated catalyst. The structured catalysts disclosed and described here may have better stability over time in comparison to other catalysts for pre-reforming. For example, the structured catalysts disclosed and described here can be manufactured using novel coatings and processes to increase catalyst stability and longevity while having less sensitivity to coke formation and operating below 500° C. to minimize coke formation. In various embodiments, a first coating or pre-coating layer may be used to enhance adhesion of an active catalyst coating to a structured substrate.

Provided here are structured catalysts that contain a structured catalyst substrate and coatings containing cerium-gadolinium oxide. In an embodiment, the structured catalyst contains a structured catalyst substrate, a first coating containing cerium-gadolinium oxide and applied to a surface of the structured catalyst substrate; and a second coating containing nickel and cerium-gadolinium oxide and applied to the first coating. The second coating can further contain ruthenium. The second coating can further contain nickel-ruthenium based catalysts. The catalyst coating can include a nickel component, a cerium oxide component, and gadolinium oxide component. In certain embodiments, the catalyst coating can include a ruthenium component, a cerium oxide component, and gadolinium oxide component. In certain embodiments, the catalyst coating can include a nickel component, a ruthenium component, a cerium oxide component, and gadolinium oxide component. The structured catalyst can contain two or more layers of the first coating. The structured catalyst can contain at least five layers of the first coating. The structured catalyst can contain two or more layers of the second coating. The structured catalyst can contain at least five layers of the second coating.

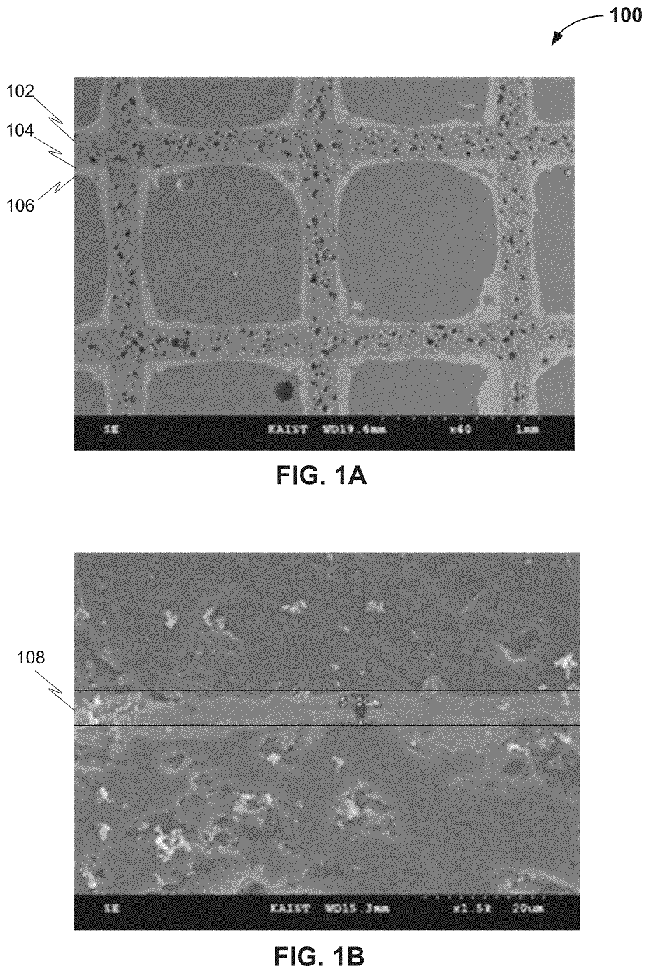

FIGS. 1A and 1B are scanning electron microscope images of a structured catalyst 100, in accordance with various embodiments. The structured catalyst 100 contains a structured catalyst substrate 102 and a first coating 104 that includes cerium-gadolinium oxide (CGO) and is applied to a surface of the structured catalyst substrate 102. A first binder is used as part of the coating solution. The structured catalyst 100 also contains a second coating 106 that includes nickel CGO and is applied to the first coating 104. A second binder is used as part of the coating solution. Usually the binder is present when the catalyst is prepared, but after calcination process, the binder is be oxidized completely. Therefore, final catalyst does not contain the binder. In certain embodiments, the first coating 104 and second coating 106 may have a combined thickness 108 of approximately 5 micrometers. In certain embodiments, the first coating 104 and second coating 106 may have a combined thickness 108 of about less than 10 μm. In certain embodiments, the structured catalyst substrate 102 may be a monolithic structured catalyst substrate. In certain embodiments, the structured catalyst substrate 102 can be a geometric monolithic structured catalyst substrate, such as a cubic structure, as seen in FIG. 1A, or a hexagonal structure or any suitable geometric structure. In certain embodiments, the structured catalyst substrate 102 can be a random porous monolithic structure. In certain embodiments, the structured catalyst substrate 102 can be made of ceramic, or metal, or combinations of metal and ceramic. In certain embodiments, the first binder may be comprised of a first polymeric material and the second binder is comprised of a second polymeric material. In various embodiments, the first and second polymeric materials may be comprised of a polyvinyl butyral resin. By way of example, the polyvinyl butyral resin may be Butvar® type of resin such as Butvar-98. Any type of binder capable of binding a CGO powder to a surface may be used to bind the first coating to the structured catalyst substrate 102. Any type of binder capable of binding a nickel CGO powder to a CGO surface may be used to bind the second coating to the first coating.

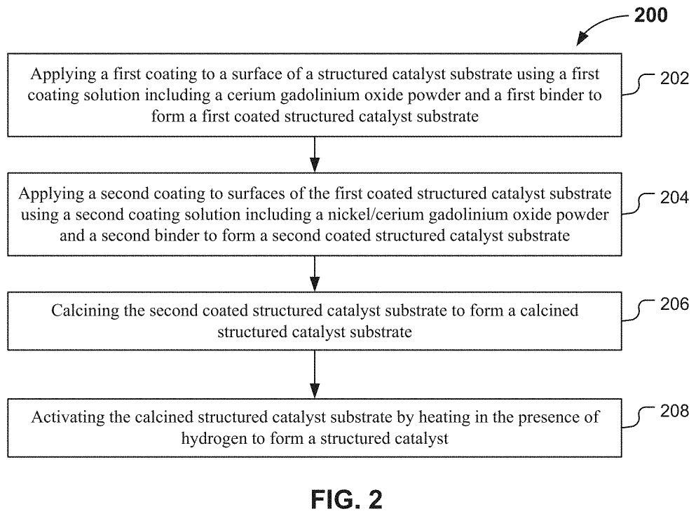

FIG. 2 is a schematic illustration of a process 200 for producing a structured catalyst, in accordance with various embodiments. At step 202 of the process 200, the process 200 includes application of a first coating to a surface of the structured catalyst substrate using a first coating solution including a cerium-gadolinium oxide powder and a first binder to form a first coated structured catalyst substrate. In certain embodiments, the structured catalyst substrate may be a monolithic structured catalyst substrate. In other embodiments, the structured catalyst substrate may be a geometric monolithic structured catalyst substrate, such as a cubic structure, as seen in FIG. 1A, or a hexagonal structure or any suitable geometric structure. In other embodiments, the structured catalyst substrate can include a random porous monolithic structure. In various embodiments, the structured catalyst substrate may be comprised of ceramic or metal or a combination thereof. In various embodiments, the first binder may be comprised of a first polymeric material and the second binder is comprised of a second polymeric material. In various embodiments, the first and second polymeric materials may be comprised of a polyvinyl butyral resin. By way of example, the polyvinyl butyral resin may be Butvar® type of resin such as Butvar-98. Any type of binder capable of binding a CGO powder to a surface may be used to bind the first coating to the structured catalyst substrate 102. Any type of binder capable of binding a nickel CGO powder to a CGO surface may be used to bind the second coating to the first coating. In certain embodiments, the process 200 can further include cleaning surfaces of the structured catalyst substrate before applying the first coating. In various embodiments, an acid or other suitable solution may be used to remove impurities from surfaces of the structured catalyst. In various embodiments, the cleaning of the surfaces of the structured catalyst substrate further can include washing the structured catalyst substrate with a 30% nitric acid solution and drying the structured catalyst substrate at 120° C. for at least one hour to provide a structured catalyst substrate having cleaned surfaces for receiving the first coating. The structured catalyst substrate can be subject to drying overnight, if required.

At step 202 of the process 200, application of the first coating can further include contacting the structured catalyst substrate with the first coating solution, removing excess amounts of the first coating solution to provide a film of the first coating solution on the structured catalyst substrate, and drying the film on the structured catalysts substrate. In various embodiments, the processes of contacting, removing, and drying may be sequentially repeated at least five times to form the first coating on the structured catalyst substrate. In various embodiments, the drying may be at 120° C. for at least one hour.

At step 202 of the process 200, the first coating solution may further include a solvent, a dispersant, and a plasticizer. The solvent can be a combination of two or more solvents, such as a mixture of 78% xylene and 22% butanol. The dispersant may be polyvinylpyrrolidone, and the plasticizer may be polyethylene glycol. In various embodiments, the solvent may be any suitable solvent for application of the first coating. In various embodiments, the dispersant may be any suitable dispersant for stabilizing the first coating solution. In various embodiments, the plasticizer may be any suitable plasticizer for the first coating solution. In various embodiments, the weight ratio of the various components in the first coating solution to the weight of the structured catalyst may be 4.0 for the CGO powder, 16.0 for the solvent, 0.2 for the dispersant, 0.2 for the plasticizer, and 0.16 for the binder.

At step 204 of the process 200, the process 200 can include application of a second coating to surfaces of the first coated structured catalyst substrate using a second coating solution including a nickel CGO powder and a second binder to form a second coated structured catalyst substrate. The first coating may enhance adhesion of the second coating. In other words, without the first coating, the second coating directly coating on the structured catalyst substrate may not have sufficient adhesion to surfaces of the structured catalyst substrate for practical use in a pre-reforming process. This second coating may delaminate and wash out without the first coating to provide adequate adhesion. The CGO coating may be referred to as a pre-coating layer. The pre-coating layer can prevent undesirable side reactions in a pre-reformer including the structured catalyst.

At step 204 of the process 200, application of the second coating can further include contacting the first coated structured catalyst substrate with the second coating solution, removing excess amounts of the second coating solution to provide a film of the second coating solution on the first coated structured catalyst substrate, and drying the film on the first coated structured catalyst substrate. In various embodiments, the processes of contacting, removing, and drying may be sequentially repeated at least five times to form the second coating on the first coated structured catalyst substrate. In various embodiments, the drying may be at 120° C. for at least one hour.

At step 204 of the process 200, the second coating solution further may include a solvent, a dispersant, and a plasticizer. The solvent can be a combination of two or more solvents, such as a mixture of 78% xylene and 22% butanol. The dispersant may be polyvinylpyrrolidone, and the plasticizer may be polyethylene glycol. In various embodiments, the solvent may be any suitable solvent for application of the second coating. In various embodiments, the dispersant may be any suitable dispersant for stabilizing the second coating solution. In various embodiments, the plasticizer may be any suitable plasticizer for the second coating solution. In various embodiments, the weight ratio of the various components in the second coating solution to the weight of the structured catalyst may be 4.0 for the nickel CGO powder, 16.0 for the solvent, 0.2 for the dispersant, 0.2 for the plasticizer, and 0.16 for the binder.

At step 206 of the process 200, the process 200 can include calcining the second coated structured catalyst substrate to form a calcined structured catalyst substrate. At step 206 of the process 200, the calcining may further comprise heating in air at a temperature of 800-1,100° C. for at least four hours, wherein the temperature of end temperature is reached by increasing the temperature over a period of six hours.

At step 208 of the process 200, the process 200 can include activating the calcined structured catalyst substrate by heating in the presence of hydrogen to form a structured catalyst. At step 208 of the process 200, the activating further may comprise heating at a temperature of 500° C. for at least four hours in an atmosphere of 30% hydrogen and 70% nitrogen. In various embodiments, the atmosphere can include a sufficient amount of hydrogen to activate the calcined structured catalyst substrate in combination with an optional gas having no or minimal impact on the activating. The optional gas may be an inert gas such as a noble gas for example. Without being bound by theory, the nickel of the second coating may be in a non-active form nickel oxide before activating. The activating may convert the non-active form into an active form of nickel in the structured catalyst.

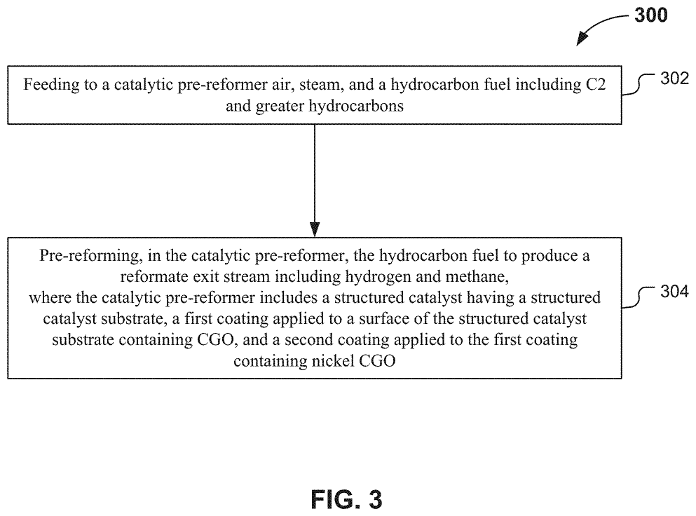

FIG. 3 is a schematic illustration of a process 300 for pre-reforming a hydrocarbon fuel, in accordance with various embodiments. At step 302 of the process 300, the process 300 can include feeding to a catalytic pre-reformer air, steam, and a hydrocarbon fuel including C2 and greater hydrocarbons. In various embodiments, the hydrocarbon fuel may be selected from the group consisting of natural gas, propane, gasoline, jet fuel, biofuel, diesel, and kerosene. In various embodiments, the hydrocarbon fuel may be a diesel fuel having impurities within reasonable engineering tolerances. In various embodiments, the catalytic pre-reforming may be a component of a SOFC and provides a synthetic gas containing methane to the SOFC.

At step 304 of the process 300, the process can include pre-reforming, in the catalytic pre-reformer, the hydrocarbon fuel to produce a reformate exit stream including hydrogen and methane, wherein the catalytic pre-reformer includes a structured catalyst having a structured catalyst substrate, a first coating applied to a surface of the structured catalyst substrate containing CGO, and a second coating applied to the first coating containing nickel CGO. In various embodiments, the structured catalyst may include the structured catalyst of FIG. 1, including the variously described embodiments disclosed in relation to FIG. 1.

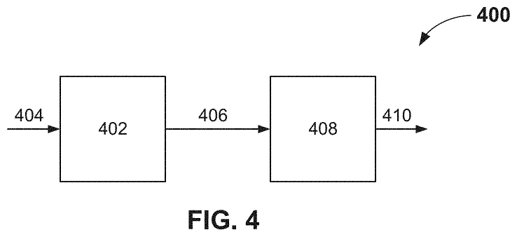

FIG. 4 is a schematic illustration of a solid oxide fuel cell device 400 with a pre-reformer 402 including a structured catalyst, in accordance with various embodiments. The device 400 may include the structured catalyst pre-reformer 402 to pre-reform a hydrocarbon fuel source 404 into a gas stream 406 including hydrogen and methane. The device 400 further may include a solid oxide fuel cell (SOFC) 408 in flow communication with the structured catalyst pre-reformer 402 to receive the gas stream 406. The device 400 may include an exhaust stream 410 to remove reactants from the SOFC 408. In various embodiments, the structured catalyst pre-reformer 402 may include a structured catalyst with a structured catalyst substrate, a first coating applied to a surface of the structured catalyst substrate and including CGO, and a second coating applied to the first coating and including nickel CGO. In various embodiments, the structured catalyst may include the structured catalyst of FIG. 1, including the variously described embodiments disclosed in relation to FIG. 1.

### EXAMPLES

Various examples are describe to illustrate selected aspects of the various embodiments of structured catalysts for pre-reforming, including systems and methods of using the catalysts.

### Example 1

In Example 1, an experimental device is disclosed and described for testing various aspects of pre-reforming catalysts including embodiments of the structured catalysts.

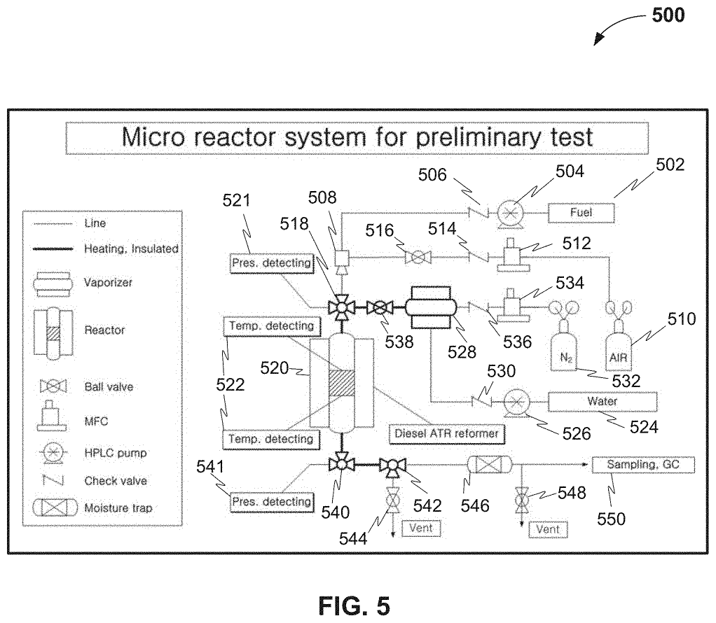

FIG. 5 is a schematic illustration of an experimental system 500 for catalytic activity testing of pre-reforming catalysts, in accordance with various embodiments. In the system 500, fuel from container 502 is pumped by a first high performance liquid chromatography (HPLC) pump 504 through a first check valve 506 and is atomized by an ultrasonic injector 518 by mixing with air from container 510 in mixer 508. The air from container 510 passes through a first mass flow controller 512, second check valve 514, and first ball valve 516. Atomized fuel with air passes through ultrasonic injector 518 to reactor 520. The reactor 520 is a pre-reformer and can be a diesel autothermal reformer as shown in FIG. 5. Ultrasonic injector 518 includes pressure detecting gauge 521. Reactor 520 includes temperature detectors 522.

The reactor 520 is made of 12.7 mm STS (stainless steel) tubes placed inside electric furnaces. The reactor 520 is controlled using PID temperature controllers and are monitored by thermocouples placed at the bottom of the catalytic bed, as indicated by temperature detectors 522. De-ionized water from container 524 (>15MΩ) is supplied by a second HPLC pump 526. The first and second HPLC pumps are from MOLEH Co. Ltd. The water from container 524 is passed through a second check valve 530 and is supplied to a steam generator 528. A small quantity of nitrogen from container 532 is also fed into the steam generator 528 and ultrasonic-injector 518 to obtain a stable delivery of the reactants. The air from container 510 and nitrogen from container 532 are metered using mass flow controllers (MKS Co. Ltd.), as illustrated. The nitrogen from container 532 passes through a second mass flow controller 534, a third check valve 536, and then to the steam generator 528 to mix with water from container 534. The mixture passes through a valve 538 and then to the ultrasonic injector 518. The effluent from the reactor 520 passes through valve 540 with pressure detecting device 541, then through valve 542 and a vent via valve 544, then through a moisture trap 546 and then to a gas chromatograph (GC) 550 for sampling. There is a vent via valve 548 between the moisture trap 546 and the GC 550. The GC 550 is gas equipped with a Thermal Conductivity Detector (TCD) and a Flame Ionization Detector (FID), which were used to analyze the composition of the effluent, also referred to as the diesel reformate in the case that diesel is the fuel. The system of FIG. 5 was used for activity testing and analysis of various structured catalysts to design and optimize the structured catalysts. Activity test was used to compare the activity and stability of the structured catalysts. The spent catalysts were analyzed by scanning electron microscope to observe the morphological changes of the structured catalysts.

### Example 2

In Example 2, various embodiments of structured pre-reforming catalysts for diesel pre-reforming were prepared. Preparation methods included various pretreatments and compositions of the structured catalysts. The structured catalysts were designed to produce methane rich gas from diesel fuel. Various embodiments of the structured catalysts consisted of CGO pre-coating layer and a catalyst layer over the CGO pre-coating layer. For comparison, structured catalysts without a CGO pre-coating layer were prepared. Without being bound by theory, the CGO pre-coating layer enhances adhesion and prevents undesired reactions. The Ni—Ru/CGO catalyst layer was formed over the CGO pre-coating layer.

In this example, a structured catalyst was prepared by washing a structured substrate with a solution of 30% by weight of nitric acid to remove impurities from surfaces of the structured catalyst substrate. The structured substrate is as illustrated in FIG. 1A, prior to application of the coatings. The washed substrate was dried at 120° C. overnight.

A CGO pre-coating slurry (first coating) was prepared by mixing the constituents in the proportions illustrated in Table 1 and then subjected to ball milling for 24 hours before coating the structured substrate. The structured substrate was coated by dipping into the first coating solution. Excess first coating solution was removed by blowing air across the structured substrate. The resulting coated structured substrate was dried at 120° C. for 1 hour. The process of dip coating, removing excess slurry, and drying were repeated for different structured substrates to provide structured substrates with different numbers of coating layers, and thus thicknesses, of the first coating. The various structured substrates were calcined in air at 800° C. for 4 hours. The temperature was ramped to 800° C. by 6 hours.

TABLE 1

| Constituent | Chemical agent | Weight ratio |
|---|---|---|
| Coating powder | CGO (first coating) or | 4.0 |
| | Ni—Ru/CGO catalyst (second coating) | |
| Solvent | 78% xylene, 22% butanol (by weight) | 16.0 |
| Dispersant | polyvinylpyrrolidone (PVPD) | 0.2 |
| Plasticizer | polyethylene glycol | 0.2 |
| Binder | Butvar B-98 | 0.16 |

The various calcined structured substrates with the CGO coating were then coated with the second coating solution with the Ni—Ru/CGO based catalyst material. The coating process was the same as with the first CGO coating solution to provide a different number of coating layers of the Ni—Ru/CGO material. The resulting substrates were calcined in air at 800° C. for 4 hours. The temperature was ramped to 800° C. by 4 hours.

SEM images of one of the various structured catalysts with two coatings are shown in FIGS. 1A and 1B. The thickness of total coating was less than approximately 10 μm for the structured catalyst shown in FIGS. 1A and 1B. Without being bound by theory, the CGO pre-coating layer (first coating layer) enhances adhesion of the Ni—Ru/CGO coating layer (second coating layer) and prevents undesired chemical reactions during diesel pre-reforming. Structured catalysts with and without the CGO pre-coating layer were tested for conversion percentage of diesel fuel in the pre-reforming device illustrated in FIG. 5.

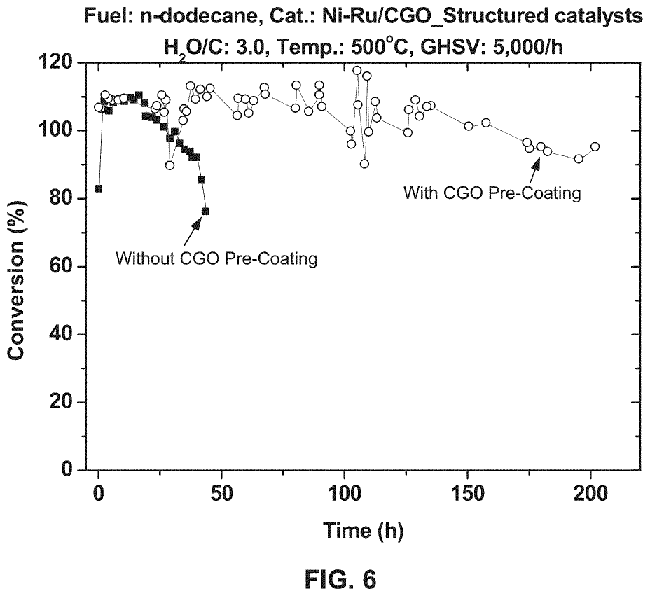

FIG. 6 is a graphical representation of conversion of n-dodecane as a function of time for structured catalysts with and without the CGO pre-coating layer for a Ni—Ru/CGO catalyst coating, in accordance with various embodiments.

Conversion is calculated as the equation below:

Conversion=(CO+CO2+CH4 production in mole basis)/(total carbon in fuel input)

However, with errors of fuel delivery pump and gas chromatography measurements, the conversion can be varied. The conversion result can be used as a reference of long-term stability.

The pre-reforming fuel used to simulate diesel fuel was n-dodecane. The water to carbon ratio was approximately three to one on mole basis. The temperature of operation of the pre-reforming was 500° C. The gas hourly space velocity (GHSV) was 5000 per hour. GSHV is equal to the reactant gas flow rate divided by the reactor volume. As can be seen in FIG. 6, the structured catalyst without the CGO pre-coating was degraded within 50 hours. In stark contrast, the structured catalyst with the CGO pre-coating was successfully operated for 200 hours with high conversion rates and with 15.6 mole percent of CH₄ concentration, which indicates much better stability as a result of using the CGO pre-coating.

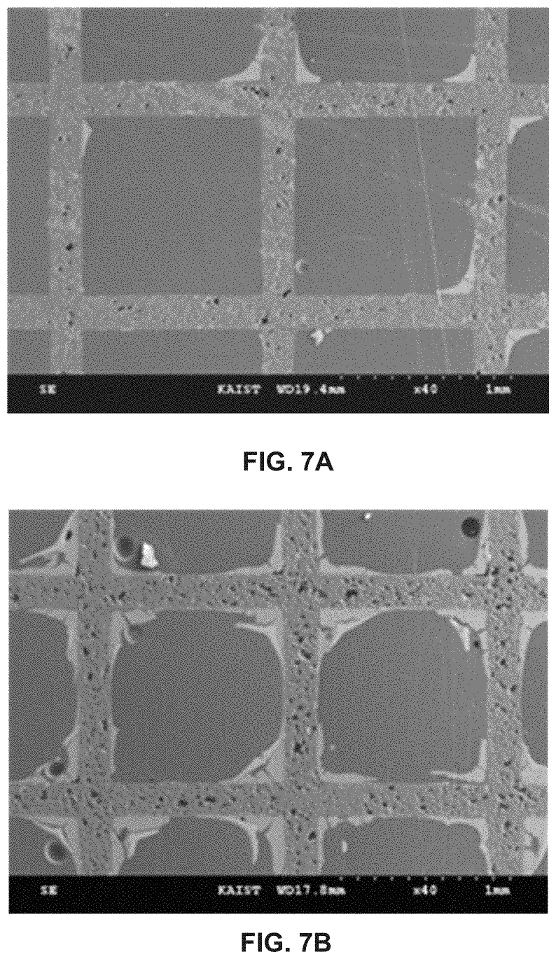

FIGS. 7A and 7B are scanning electron microscopy (SEM) images of spent structured catalysts with and without a CGO pre-coating, in accordance with various embodiments. FIG. 7A is the structured catalyst without the CGO pre-coating. As can be seen in FIG. 7A, the catalyst coating on the structured substrate is mostly removed, indicating a loss of catalytic activity of the structured catalyst. FIG. 7B is the structured catalyst with the CGO pre-coating. As can be seen in FIG. 7B, the catalyst coating remains adhered to the structured catalyst, indicating continued activity of the structured catalyst. In comparing FIGS. 7A and 7B, the catalyst layer was washed out without CGO pre-coating. Without being bound by theory, Ni—Ru/CGO-based catalyst expands and contracts repeatedly by redox and nickel-carbon (NiC) formation. This expansion and contraction accelerates the delamination of catalyst layer during pre-reforming process. Unlike the structured catalysts without pre-coating, the Ni—Ru/CGO coating layer remained on substrates after the test, which indicates that the delamination is prevented by the introduction of CGO pre-coating layer to provide stability to the coating. The Ni—Ru/CGO coating by itself is not as stable as when the pre-coating CGO layer is added to the structured catalyst.

### Example 3

In Example 3, various embodiments of the structured catalysts were prepared with different numbers of coating layers of CGO pre-coating and the Ni—Ru/CGO catalyst coating layer. The purpose of varying the coating layer was to optimize the number of layers for the structured catalysts. The purpose of optimizing the number of coating layers was to determine whether there is an optimum number of coating layers to reduce the cost and the time of preparation of various embodiments of the structured catalysts for pre-reforming. The thickness of coating layer was observed using scanning electron microscope (SEM).

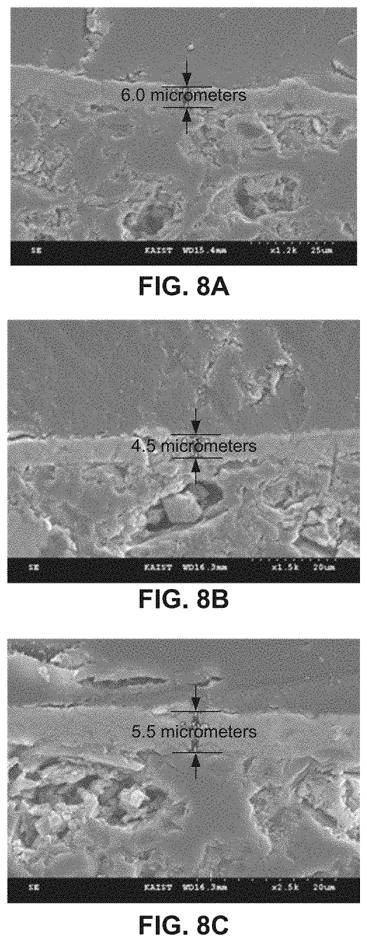

FIGS. 8A, 8B, and 8C schematically illustrate SEM images of three structured catalysts with five, seven, and nine layers of Ni—Ru/CGO coating layer respectively, in accordance with various embodiments. The thickness of the Ni—Ru/CGO coating layer was 6.0, 4.5, and 5.5 micrometers for coating layer numbers five, seven, and nine, respectively, as illustrated in FIGS. 8A, 8B, and 8C. As the thickness of the Ni—Ru/CGO coating did not seem to increase as the number of coating layers increased from five to nine, this result indicates that additional coating layers beyond five may not be advantageous to increase thickness. Without being bound by theory, this result may indicate that additional coating steps may be partially removing the previously existing coating layers. Based on these results, an optimal coating layer number may be approximately five.

### Example 4

In Example 4, heat treatment of the CGO pre-coating layer was conducted at various temperatures to evaluate effect of heat on various embodiments of the structured catalysts. After coating a structured catalyst substrate with a CGO pre-coating layer, the substrate was heat treated before the Ni—Ru/CGO catalyst layer was added on top of the CGO pre-coating. Without being bound by theory, the purpose of the heat treatment is to prevent removal of the CGO pre-coating layer during the addition of the Ni—Ru/CGO catalyst layer on top of the CGO pre-coating layer. The heat treatment temperature was varied to identify temperatures in which a stable CGO layer is formed on the structured substrate.

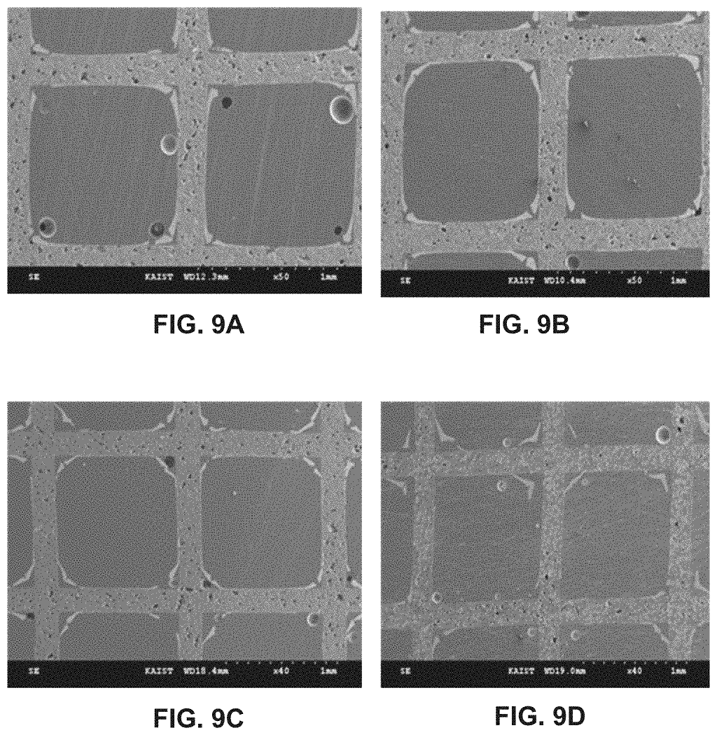

FIGS. 9A, 9B, 9C, and 9D are scanning electron microscope images of structured substrates with CGO pre-coating followed by heat treatment at 800° C., 900° C., 1000° C., and 1,100° C., respectively, in accordance with various embodiments. As can be seen in the images, the CGO pre-coating is substantially adhered to the structured substrate at 800° C. treatment temperature. However, as the temperature is increased, the CGO pre-coating layer becomes more delaminated from the structured substrate. At the highest temperature of 1,100° C., the CGO pre-coating appears to be mostly delaminated from the structured substrate. Accordingly, a heat treatment temperature of approximately 800° C. or less appears to provide a better CGO pre-coating layer for subsequent attachment of a Ni—Ru/CGO catalyst layer.

### Example 5

In Example 5, a comparison is made between an embodiment of the structured (monolith) catalysts and a non-structured (granular or granulated) catalyst in a pre-reforming reaction of n-dodecane fuel using the device of FIG. 1.

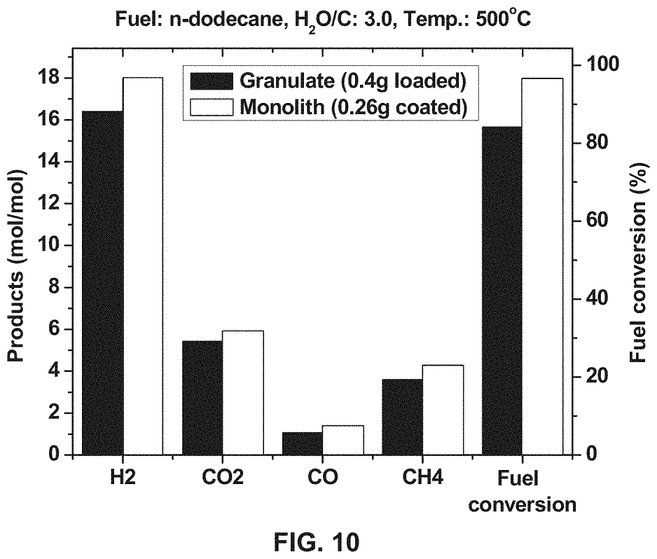

FIG. 10 is a graphical representation of a comparison of a granular catalyst and a structured catalyst in a pre-reforming device, in accordance with various embodiments. The fuel used for the comparison was n-dodecane. The water to carbon ratio was three to one by mole basis. The temperature of the pre-reforming reaction was 500° C. The Ni—Ru/CGO catalyst loaded on the granulated catalyst was 0.4 grams, and the Ni—Ru/CGO catalyst loaded on the monolith catalyst was 0.26 grams. The catalysts were loaded in the reactor separately and tested separately for conversion of n-dodecane in the pre-reforming reactor of FIG. 5. The results in FIG. 10 show that a significantly reduced amount of Ni—Ru/CGO catalyst was utilized when using the structured catalysts in comparison to the granulated catalyst. When using the structured monolith catalyst, approximately 97% of n-dodecane was converted to synthetic gas. On the other hand, fuel conversion was less than 90% for the granulated catalyst, approximately 84%. Without being bound by theory, the superiority of the structured catalyst likely is due to a higher mass transfer coefficient in comparison to the granulated catalyst. Based on the experimental results, consumption of the Ni—Ru/CGO catalyst amount may be reduced by approximately at least 35% when using the structured catalyst instead of the granulated catalyst.

Ranges may be expressed in this disclosure as from about one particular value, and/or to about another particular value. When such a range is expressed, it is to be understood that another embodiment is from the one particular value and/or to the other particular value, along with all combinations within said range.

It will be understood that certain of the above-described structures, functions, and operations of the above-described embodiments are not necessary to practice the present invention and are included in the description simply for completeness of an exemplary embodiment or embodiments. It is therefore to be understood that various changes, substitutions, and alterations can be made hereupon without departing from the principle and scope of the invention. There various elements described can be used in combination with all other elements described herein unless otherwise indicated.

We claim:

1. A process for pre-reforming a hydrocarbon fuel, comprising:
feeding to a catalytic pre-reformer air, steam, and a hydrocarbon fuel including C2 and greater hydrocarbons; and
pre-reforming, in the catalytic pre-reformer, the hydrocarbon fuel to produce a reformate exit stream including hydrogen and methane,
wherein the catalytic pre-reformer includes a structured catalyst having a structured catalyst substrate, a first coating containing cerium-gadolinium oxide; and a second coating containing nickel and cerium-gadolinium oxide;
and wherein the structured catalyst substrate comprises a monolithic structured catalyst substrate.

2. The process of claim 1, wherein the hydrocarbon fuel is selected from the group consisting of natural gas, propane, gasoline, jet fuel, biofuel, diesel, and kerosene.

3. The process of claim 1, wherein the second coating further comprises ruthenium.

4. The process of claim 1, wherein the structured catalyst comprises two or more layers of the second coating.
